(19) United States
(12) Patent Application Publication
(10) Pub. No.: US 2008/0221246 A1
(43) Pub. Date: Sep. 11, 2008

(54) Water soluble films from latex

(75) Inventors: Syed H. Imam, Walnut Creek, CA (US); Gregory M. Glenn, American Canyon, CA (US); William J. Orts, Burlingame, CA (US)

Correspondence Address: USDA-ARS-OFFICE OF TECHNOLOGY TRANSFER;PATENT ADVISORS OFFICE, WESTERN REGIONAL RESEARCH CENTER, 800 BUCHANAN ST, ALBANY, CA, 94710, US

(73) Assignee: The United States of America, as represented by the Secretary of Agriculture, Washington, DC (US)

(21) Appl. No.: 11/716,434

(22) Filed: Mar. 9, 2007

(51) Int. Cl. C08J 7/02; C08L 9/10

(52) U.S. Cl. 524/271; 524/300; 524/306; 524/310; 524/311; 524/317; 524/387; 524/388; 524/498; 524/571; 525/55

(57) ABSTRACT

Water soluble latex compositions comprising cis 1,4 polyisoprene and a biopolymer are disclosed. The compositions may contain 0.1-10% cis 1,4 polyisoprene and are suitable for application wherein a biodegradeable water soluble product is desired.

### FIELD OF THE INVENTION

The present invention relates to water soluble latex film compositions.

### DETAILED DESCRIPTION OF THE INVENTION

The present invention will now be described by reference to more detailed embodiments, with occasional reference to the accompanying tables. This invention may, however, be embodied in different forms and should not be construed as limited to the embodiments set forth herein

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurement.

The term “starch” as used herein refers to polymers containing amylose, amylopectin, the naturally-occurring starch molecules that are found in plants such as corn, potato, rice, barley, wheat, oats, triticale, rye, sorghum, root and tuber starch, such as potato, tapioca (also known as Cassaya) yam, sweet potato and Canna starch; as well as modified starch. Examples of modified starch include, but are not limited to, starch that has been modified through partial hydrolysis, cross-linking, substitution, dextrinization, etc. Examples of intermediates of starch hydrolysis include, but are not limited to, dextrin, maltodextrin, corn syrup, etc.

The term “plasticizer” refers to an additive that increases the flexibility and durability of the final product such.

The term “fiber” refers to a plant derived complex carbohydrate categorized as either water soluble or water insoluble; as well as a class of materials (natural or synthetic) of various geometries (shapes & sizes) determined by their length and diameter (L/D) ratio. They may vary in their shape such as filamentous, cylindrical, oval, round, elongated and globular. Their size may range from nanometers up to millimeters. As an additive in a latex film, fibers serve as a filler material that provides gentle scrubbiness and dimensional stability to the final product.

The term “biopolymer” refers to repeating units of biological or chemical moieties which are of a biodegradable nature.

According to an embodiment of the invention herein is described a water soluble film containing cis-1,4-polyisoprene, a biopolymer and optionally a plasticizer. A further embodiment of the invention describes the use of additives such as fibers, colors, mild detergents, fragrances, minerals, oils, inorganic clays to impart a desired property, such as tactility or dispersion.

The cis-1,4-polyisoprene can be derived from either natural or synthetic sources, including but not limited to Guayule or Hevea plants. The cis-1,4 polyisoprene may be present in an amount of 0.1-10% by weight, preferably about 1 to 5%.

In practicing the present invention, suitable latices may be obtained from various plant sources. Among the plant materials that can be used as sources of natural rubber latices are the Brazilian (Para) rubber tree (Hevea brasiliensis), guayule and its relatives (Parthenium argentatum, incanum, stramonium var. tomentosum, et al.), it being understood that reference to guayule within this specification will include all relatives thereof, the rubber plant (Ficus elastica), rabbit-brush (Crysothamnus nauseosus), Madagascar rubber vine (Cryptostegia grandiflora), milkweeds (Asclepias syriaca, speciosa, subulata et al.) pale Indian plantain (Cacalia atriplicifolia), Russian dandelion (Taraxacum bicome), mountain mint (Pycnanthemum incanum), American germander (Teucreum candense), and tall bellflower (Campanula americana). Many other plants that produce cis-1,4-polyisoprene are known, particularly among the Asteraceae, Euphorbiaceae, Campanulaceae, Labiatae, and Moraceae families. It is to be understood that the rubbers from these plants—including guayule—fall under the general classification of natural rubbers and hence can be utilized either alone or in combination with each other in practicing the present invention. It should be further understood that the term natural rubber or simply rubber as used herein refers to that polyisoprene believed to be cis-1,4-polyisoprene, obtained from plant life as discussed above, as well as any naturally occurring derivatives thereof found in plant life.

The film composition may be prepared at room temperature by admixture of the cis-1,4-polyisoprene and a biopolymer. To impart a desired degree of flexibility a plasticizer may also be added to the admixture of cis-1,4-polyisoprene and a biopolymer. Additionally to impart other physical properties such as tactility and strength, crosslinking agents set forth below may be employed. Upon direct contact with water, the film starts to disintegrate and total dissolution is achieved within a few minutes. In the absence of direct contact with water, but under appreciably moist conditions, the time for dissolution is increased.

The biodegradability of the film increases with the increase in aqueous concentration, therefore the composition finds utility in any application wherein a biodegradeable water soluble product is desired. Applications include, but are not limited to, single use products such as wet wipes or reusable cleaning towels or cloths, packaging material for disposable consumer goods, as well as flushable items commonly processed by sewage treatment plants, delivery vehicles for drugs, chemicals, insecticides and other active compounds.

The composition is also made to contain a plasticizer which is present in an amount of 0.1 to 50% by weight, preferably about 1 to 3% by weight of a plasticizer. Any known plasticizers can be used, examples thereof including the following: sorbitol, triacetin, diacetin, monoacetin, triethyl citrate, tributyl citrate, acetyl triethyl citrate, acetyl tributyl citrate, dimethyl succinate, diethyl succinate, oligoesters of amber acid and diols, ethyl lactate, methyl lactate, glycerol, fatty acid esters of glycerol, polyethylene glycol castor oil, olive oil, rapeseed oil, tall oil, dibutyl phthalate, diethyl phthalate, and mixtures thereof.

The composition additionally contains a biopolymer to impart varying degrees of water solubility or tensile strength. Biopolymers include, but are not limited to proteins, peptides, lipids, oligosaccharides, polysaccharides (starch, pectin, dextran, pullulan, carrageenan, gums—arabic, locust, guar, tragacanth; cellulose, carboxymethyl cellulose), poly-(lactic acid), poly-(hydroxyl-butyrate-co-valerate), gelatin, agar, alginic acid, sodium alginate, gluten, polyisoprene, rice straw, wheat, recycled paper, recycled pulp, guayule stem bagasse, avian feathers, pectin, chitosan, COLLATEX®, coconut fiber, soft wood, cotton, carrageenan, polyvinyl alcohol (PVA). Biopolymers may be in a concentration of 0.1-5%, preferably 0.1-0.3%.

Further additives may be used to impart desired properties to the film, including colors, mild detergents, fragrances, minerals, oils, inorganic clays, alcohols (ethanol, methanol, 2-propanol), silic acid, talc, salts (chlorides, phosphates, carbonates, etc) and microfibrils.

Crosslinking agents may also be employed to improve tensile strength including but not limited to epichlorohydrin, melamine reagent (hexamethoxymethyl melamine), derivatives of ethylene glycol di(meth)acrylate, derivatives of methylenebiscrylamide, formaldehyde free crosslinking agent and divinylbenzene. Crosslinking agents may be in a concentration of 0.1-5%, preferably 0.5-3%.

Although not limited to the embodiments set forth below, representative compositions are set forth in Table 1.

TABLE 1
Film Compositions

| | | | |
|---|---|---|---|
| 3% latex | 3% pectin | a) 1% sorbitol | |
| | | b) 1% PEG | |
| | | c) 2% PEG | |
| 3% latex | 2% cymel 385 | a) 1% sorbitol | |
| | | b) 1% PEG | |
| | | c) 2% PEG | |
| 3% latex | 3% pectin | 1-3% sorbitol | a) .2% fiber |
| | | | guayule stem |
| | | | bagasse |
| | | | b) .2% rice |
| | | | c) .2% recycled |
| | | | paper |
| | | | e) .2% wheat |
| 3% latex | 3% cmc | a) .1% cymel 385 | |
| | | b) .5% | |
| | | epichlorohydrin | |
| 3% latex | 3% CMC | | a) .2% fiber |
| | | | guayule stem |
| | | | bagasse |
| | | | b) .2% rice |
| | | | c) .2% recycled |
| | | | paper |
| | | | e) .2% wheat |
| 3% latex | 3% pregel | a) 1% cymel 385 | a) .2% fiber |
| | | b) .5% | guayule stem |
| | | epichlorohydrin | bagasse |
| | | | b) .2% rice |
| | | | c) .2% recycled |
| | | | paper |
| | | | d) .2% wheat |
| 3% latex | 3% pregel | a) 1% cymel 385 | a) .2% chicken |
| | | b) .5% | feather |
| | | epichlorohydrin | b) .2% gauyule |
| | | | stem bagasse |
| | | | c) .2% rice |
| | | | d) .2% recycled |
| | | | paper |
| | | | e) .2% wheat |
| 3% latex | .5% PVA | 3% CMC | |
| | 1% PVA | | |
| | 2% PVA | | |
| 3% latex | 3% carrageenan | a) 1% sorbitol | |
| | | b) 1% PEG | |
| | | c) 2% PEG | |

Films are generally prepared at room temperature by mixing the constituents via stirring, agitation, or other mixing techniques known in the art and can be molded to a desired thickness and length by casting, pressing, calendaring, blowing and molding, wherein single or twin-screw extrusion may be used. Alternatively, the addition of minute amounts of non-ionic additives such as Nonidet P 40, TRITON® X-100, TWEENS 20, KODAK PHOTO-FLO or any other electrically neutral cleaning agent help in the dispersion of latex upon formulation.

Prior to dissolution, the film compositions exhibit physical properties such as tensile strength and percent elongation (Table 2). Although the films are water soluble, the dissolution time may be varied by one of skill in the art by increasing the concentration of the cis-1,4-polyisoprene and biopolymer constituents. Films stored at room conditions (23° C., 50% relative humidity (RH)) for several months showed little or no deterioration.

TABLE 2
Tensile properties of latex-pectin films with and without fiber.

| | | Average | Average | Average |
|---|---|---|---|---|
| | Number of | Elastic | Elongation | Load at |
| | Samples | Modulus | at Break | Max. |
| Film Sample | Analyzed | (MPa) | (Mpa) % | Load (N) |
| Latex + pectin (no | 5 | 18.126 | 172.065 | 18.327 |
| fiber) | | | | |
| Latex + Pectin + wheat | 5 | 31.008 | 65.241 | 18.445 |
| fiber | | | | |
| Latex + pectin + rice | 6 | 35.227 | 60.376 | 25.800 |
| fiber | | | | |
| Latex + pectin + | 7 | 24.945 | 90.912 | 18.475 |
| guayule fiber | | | | |
| Latex + pectin + maple | 6 | 30.421 | 62.912 | 21.748 |
| wood fiber | | | | |
| Latex + pectin + sun | 5 | 40.666 | 91.836 | 32.075 |
| flower fiber | | | | |

Dog-bone shaped film samples were stamped-cut for testing.
Sample Rate (pts/secs); 10.000
Full Scale Load Range: 1.000 kN
Temperature 25° C.
Cross Speed: 55.000 mm/min
Humidity(%) 31
Grip Press. 20 psi

What is claimed:

1. A water soluble latex composition comprising about 0.1-10% (w/w) cis-1,4 polyisoprene and a biopolymer.

2. A water soluble latex composition comprising cis-1,4 polyisoprene, a biopolymer and a plasticizer.

3. The composition of claim 2, wherein the cis-1,4 polyisoprene is about 0.1-10%, (w/w).

4. The composition of claim 1, wherein the cis-1,4 polyisoprene is 1-5% (w/w) of the composition.

5. The composition of claim 1 or 2, wherein the biopolymer is selected from the group consisting of proteins, peptides, lipids, oligosaccharides, polysaccharides (starch, pectin, dextran, pullulan, carrageenan, gums—arabic, locust, guar, tragacanth; cellulose, carboxymethyl cellulose), poly-(lactic acid), poly-(hydroxyl-butyrate-co-valerate), gelatin, agar, alginic acid, sodium alginate, gluten, polyisoprene, rice straw, wheat, recycled paper, recycled pulp, guayule stem bagasse, avian feathers, pectin, chitosan, COLLATEX®, coconut fiber, soft wood, cotton, carrageenan, polyvinyl alcohol.

6. The composition of claim 1, further comprising a plasticizer.

7. The composition of claim 2 or 6, wherein the plasticizer is selected from the group consisting of sorbitol, triacetin, diacetin, monoacetin, triethyl citrate, tributyl citrate, acetyl triethyl citrate, acetyl tributyl citrate, dimethyl succinate, diethyl succinate, oligoesters of amber acid and diols, ethyl lactate, methyl lactate, glycerol, fatty acid esters of glycerol, polyethylene glycol castor oil, olive oil, rapeseed oil, tall oil, dibutyl phthalate, diethyl phthalate, and mixtures thereof.

8. The composition of claim 5, wherein the biopolymer is 1-5% (w/w) of the latex composition.

9. The composition of claim 1 or 2, further containing additives selected from the group consisting of colors, mild detergents, fragrances, minerals, oils, inorganic clays, alcohols, silic acid, talc, salts and microfibrils.

10. The composition of claim 1 in the form of a film.

11. A method of making a latex film comprising:
(i) Adding cis-1,4 polyisoprene to an aqueous solution such that the polyisoprene is 0.1-10% w/w of the solution,
(ii) adding a biopolymer at 1-3% w/w, and (iii) optionally adding a plasticizer.

12. The method of claim 11, wherein the biopolymer is selected from the group consisting of proteins, peptides, lipids, oligosaccharides, polysaccharides (starch, pectin, dextran, pullulan, carrageenan, gums—arabic, locust, guar, tragacanth, cellulose, carboxymethyl cellulose), poly-(lactic acid), poly-(hydroxyl-butyrate-co-valerate), gelatin, agar, alginic acid, sodium alginate, gluten, polyisoprene, rice straw, wheat, recycled paper, recycled pulp, guayule stem bagasse, avian feathers, pectin, chitosan, COLLATEX®, coconut fiber, soft wood, cotton, carrageenan, polyvinyl alcohol.

13. The method of claim 11, wherein the plasticizer is selected from the group consisting of sorbitol, triacetin, diacetin, monoacetin, triethyl citrate, tributyl citrate, acetyl triethyl citrate, acetyl tributyl citrate, dimethyl succinate, diethyl succinate, oligoesters of amber acid and diols, ethyl lactate, methyl lactate, glycerol, fatty acid esters of glycerol, polyethylene glycol castor oil, olive oil, rapeseed oil, tall oil, dibutyl phthalate, diethyl phthalate, and mixtures thereof.

14. The method of claim 11, further comprising an additive selected from the group consisting of colors, mild detergents, fragrances, minerals, oils, inorganic clays, alcohols, silic acid, talc, salts and microfibrils.

15. The method of claim 11 further comprising molding after step (ii) or (iii).

16. The method of claim 11 further comprising a non-ionic detergent.
